(19) United States
(12) Patent Application Publication
(10) Pub. No.: US 2019/0346658 A1
(43) Pub. Date: Nov. 14, 2019

(54) OPTICAL DEVICES INCLUDING ROTARY VARIABLE OPTICAL ELEMENTS

(71) Applicant: PRESIDENT AND FELLOWS OF HARVARD COLLEGE, Cambridge, MA (US)

(72) Inventors: Alan Jenting SHE, Cambridge, MA (US); Shuyan ZHANG, Cambridge, MA (US); Federico CAPASSO, Cambridge, MA (US)

(73) Assignee: PRESIDENT AND FELLOWS OF HARVARD COLLEGE, Cambridge, MA (US)

(21) Appl. No.: 16/479,204

(22) PCT Filed: Jan. 19, 2018
(86) PCT No.: PCT/US2018/014539

§ 371 Date: Jul. 18, 2019

Related U.S. Application Data
(60) Provisional application No. 62/448,825, filed on Jan. 20, 2017.

(51) Int. Cl. G02B 7/10; G02B 7/02; G02B 1/00; G02B 3/10; G02B 3/08

(52) U.S. Cl. CPC G02B 7/10; G02B 7/021; G02B 3/08; G02B 3/10; G02B 1/002

(57) ABSTRACT

A collection of optical sub-elements can be arranged sequentially, such that they share a common optical axis through which light propagates. Each of these optical sub-elements can alter a phase, an amplitude, or a polarization of incident light, by virtue of its surface curvature, such as, for example, in a refractive optical element, or using microscale and nanoscale structures, such as, for example, in a diffractive optical element. One or more of these optical sub-elements can be rotated to tune one or more parameters, such as focal power, of the complete device.

### CROSS REFERENCE TO RELATED APPLICATIONS

This application claims the benefit of and priority to U.S. Provisional Application No. 62/448,825, filed on Jan. 20, 2017, entitled “Optical Devices Including Rotary Variable Optical Elements,” which is incorporated by reference herein in its entirety.

### STATEMENT OF FEDERALLY SPONSORED RESEARCH OR DEVELOPMENT

This invention was made with Government support under FA9550-14-1-0389 awarded by the Air Force Office of Scientific Research. The Government has certain rights in the invention.

### BACKGROUND

Several optical devices include the capability of changing the power or focal length of their optical elements. The optical elements can be formed using one or more spherical or aspherical optical lenses, the relative spatial arrangement of which can be changed to change the focal length of the aggregate optical element. In some applications, other aspects of the lenses also can be changed to change a polarization and an amplitude of the light passing through the lenses. However, the optical elements formed using such spherical or aspherical optical lenses can be bulky, and add complexity to the optics devices.

### SUMMARY

The present disclosure describes an optical device including a plurality of optical sub-elements (OSEs), and a rotatable chassis supporting the plurality of OSEs, where the rotatable chassis configured to set relative angular positions of at least two OSEs of the plurality of OSEs. A focal length of the optical device is based on relative angular positions of at least two OSEs of the plurality of OSEs. In one or more embodiments, the phase profile of each of the at least two OSEs of the plurality of OSEs can be spiral shaped and rotationally asymmetric. In one or more embodiments, the phase profile of at least one OSE of the plurality of OSEs can be a phase conjugate of a phase profile of another OSE of the plurality of OSEs. In one or more embodiments, the at least two OSEs can be positioned in close proximity to each other at a distance of about 10 μm to about 2 μm from each other. In one or more embodiments, the surface geometry of at least one of the at least two OSEs of the plurality of OSEs can define an optical path length, which is based on the respective phase profile. In one or more embodiments, the phase profile can be modified using a phase discontinuity distribution function. In one or more embodiments, at least one OSE of the plurality of OSEs can be a planar optical element (POE). In one or more embodiments, the POE can include a metasurface. In one or more embodiments, the optical device can further include a controller communicably coupled to the rotatable chassis, where the rotatable chassis sets the relative angular positions of the at least two OSEs based on a signal received from the controller. In one or more embodiments, the optical device can further include an actuator, such as at least one of an electric motor, a piezoelectric motor, or a microelectromechanical systems (MEMS) driver. In one or more embodiments, the OSEs can be configured to be positioned in relation to an image sensor to process light entering the image sensor or a light source for projection.

The present disclosure describes a method including providing a plurality of optical sub-elements (OSEs) of an optical device. The method further includes determining relative angular positions of at least two OSEs of the plurality of OSEs corresponding to a focal length of the plurality of OSEs. The method also includes controlling a rotatable chassis supporting the OSEs to set the positions of the at least two OSEs. In one or more embodiments, a phase profile of each of the at least two OSEs of the plurality of OSEs is spiral shaped and rotationally asymmetric, and wherein determining the relative angular positions includes determining the relative angular positions based on the phase profile of each of the at least two OSEs. In one or more embodiments, a phase profile of at least one OSE of the plurality of OSEs is a phase conjugate of a phase profile of another OSE of the plurality of OSEs. In one or more embodiments, the method can further include positioning the at least two OSEs at a distance of about 10 μm to about 2 μm from each other. In one or more embodiments, the phase profile of at least one OSE of the plurality of OSEs is specified based on a phase discontinuity distribution function. In one or more embodiments, at least one OSE of the plurality of OSEs is a planar optical element (POE). In one or more embodiments, controlling a rotatable chassis supporting the OSEs includes controlling at least one of an electric motor, a piezoelectric motor, and a microelectromechanical systems (MEMS) driver. In one or more embodiments, the method further includes receiving light from a light sensor at the plurality of OSEs and providing light from the plurality of OSEs to an image sensor. In one or more embodiments, the method also includes receiving light from an image sensor at the plurality of OSEs and providing light from the plurality of OSEs to a projection screen.

### BRIEF DESCRIPTION OF THE DRAWINGS

FIG. 1 depicts a representation of an optical device including two optical sub-elements.

FIGS. 2A and 2B show representations of net phase profiles of an optical device having at least two optical sub-elements arranged at relative angles of 10.8° and 54°, respectively.

FIG. 3 depicts a representation of an example phase profile of an optical sub-element utilizing phase discontinuity distribution.

FIG. 4 depicts representations of net phase profiles of an optical device using two optical sub-elements.

FIGS. 5A and 5B depict representations of optical sub-elements formed using bulky optics.

FIG. 6 depicts a representation of an example optical device including planar tunable lenses.

FIG. 7 depicts an expanded view of another example optical device used in conjunction with an optical sensor.

### DETAILED DESCRIPTION

Variable-power, or variable-focal length, lenses are highly desirable, especially in the areas of imaging and optical engineering. Whereas optical elements are usually static objects in terms of their engineering parameters, such as focal length and so on, the following discussion provides a general approach as well as specific examples of devices, in which one or more of such engineering parameters can be tuned by adjusting the relative angle between two or more constituent optical sub-elements (OSEs). These OSEs are objects that can individually alter the phase, amplitude, and/or polarization of incident light, such as by means of a carefully constructed surface curvature, e.g. refractive optics, or microscale and nanoscale structures, e.g. diffractive optics. In this way, a variety of conventional yet static optical devices can be adapted to form variable-power or variable-focal length lenses.

Furthermore, traditionally bulky optical devices such as lenses can be replaced with planar optical elements (POEs), which are thin, flat devices with same functionality as the bulky lenses. Nearly all optical devices today can be constructed using specifically constructed POEs. The planar property of the POEs can be fully leveraged by the rotary architecture to construct a wide range of tunable optical devices. Electrical tunability and time-varying control to optical elements can be implemented using a variety of actuation methods to construct varifocal lenses.

POEs control a wave-front of light by using arrays of fixed optical phase shifters, amplitude modulators, or polarization changing elements, which are arranged on a surface to introduce a desired spatial distribution of optical phase, amplitude, and/or polarization. By appropriately arranging each POE in an array of POEs, one can spatially control these properties of the transmitted, reflected, or scattered light and consequently alter the wave-front. This technique can be used to implement devices such as lenses, axicons, blazed gratings, vortex plates and wave plates. The resulting devices can be thin and lightweight. POEs also can be implemented based on metasurfaces, which are, in turn, based on subwavelength-spaced phase shifters. However, the phase shifters can also be wavelength-scale phased arrays or photonic crystals.

A collection of N OSEs can be arranged sequentially such that they share a common optical axis through which light propagates. Each of these OSEs is an object that can alter the phase, amplitude, or polarization of incident light, by virtue of their surface curvature, such as, for example, in a refractive optical element, or using microscale and nanoscale structures, such as, for example, in a diffractive optical element. One or more of these OSEs can be rotated to tune one or more parameters of the complete device, such as focal power.

An optical function F(x,y) can be defined for an OSE, which describes a transformation of phase, amplitude, and polarization of light incident on the OSE. Based on this transformation function, phase, amplitude, and polarization profiles of light transformed by the OSE can be expressed, for example, below in Equation (1):

(φ′(x,y),A′(x,y),P′(x,y))=F((φ(x,y),A(x,y),P(x,y)) (1)

where φ, A, and P are the phase, amplitude, and polarization corresponding to a complex-valued vector amplitude of an aperture function of a light field, respectively, describing the light before interacting with the OSE; φ′, A′, and P′ are the phase, amplitude, and polarization, respectively, after interacting with the OSE; and x,y are the horizontal and vertical coordinates in the plane of the OSE. In one or more example embodiments, the optical function F(x, y) can be expressed using a linear transformation matrix, such as optical transfer matrix.

The action of N OSEs arranged in sequence through which the incident light passes on its phase, amplitude and polarization can be expressed, for example, below in Equation (2):

Fₙₑₜ=F_{N}∘ . . . ∘F₂∘F₁(x,y) (2)

where Fₙₑₜ represents the combined effect of N OSEs in sequence on the incident light.

In one or more example embodiments, the changes to the phase profile of the incident light may be of particular interest. In an ordinary thin lens, a thickness profile of a glass through which light propagates translates directly to the path length profile, which in turn can be represented as a phase shift profile or phase profile. Similarly, in many other devices, such as flat lenses, metasurfaces, and diffractive optical elements, the phase profile can be designed using nanostructures, such as surface relief structures that impose a locally controlled phase. For example, phase profiles of N OSEs arranged in sequence can be expressed, for example, using the following Equation (3):

ϕ₁,ϕ₂, . . . ϕ_{N} (3)

where ϕ₁, ϕ₂, and ϕ_{N}, denote the phase profiles of the first, second, and the Nth OSE of the N OSEs arranged in sequence. Each of these phase profiles can be expressed as a spatial function of the area of the planar OSE (of a two-dimensional projected area of a nonplanar OSE) in terms of a Cartesian coordinate system (x,y) and equivalently in terms of a polar coordinate system (r, θ), as shown, for example, below in Equations 4A-4C:

ϕ₁=ϕ₁(x,y)≡ϕ₁(r,θ) (4A)

ϕ₂=ϕ₂(x,y)≡ϕ₂(r,θ) (4B)

ϕ_{N}=ϕ_{N}(x,y)≡ϕ_{N}(r,θ) (4C)

OSEs arranged in close proximity with adjacent OSEs in an array generate a net phase profile imposed on light passing through all OSEs in the array. The net phase profile can be approximately represented by the sum of the phase profiles of individual OSEs within the array, as expressed, for example, in Equation (5) below:

ϕₙₑₜΣₙ₌₁^{N}ϕₙ (5)

where ϕₙₑₜ denotes the net phase profile of N OSEs in the array, and ϕₙ denotes the phase profile of an individual OSE in the array. In some example implementations, the distance between adjacent OSEs can be about 10 μm to about 2 μm. In some example implementations, this distance can be different for different OSE designs. The higher the local bending angle experienced by light at one OSE, the closer the next OSE should be located. For a varifocal lens with higher focal power (shorter focal length and higher bending angles) the adjacent OSEs can be positioned closer than that for a varifocal lens with lower focal power.

If the OSEs are not in close proximity, then the phase profile of each OSE can be corrected, for example, using the transformation expressed below in Equation (6):

ϕₙ→ϕₙ=Cₙ(ϕₙ) (6)

where Cₙ is the calculated correction function corresponding to phase profile ϕₙ of each of the N OSEs.

The net phase profile ϕₙₑₜ describes the change of the angle of each OSE that provides tunability for an optical device including the N OSEs in sequence. By including the rotation R(θₙ) corresponding to each ϕₙ, ϕₙₑₜ, as expressed below in Equation (7), is a function of the angles θₙ of each of the N OSEs:

ϕₙₑₜ(θ₁,θ₂, . . . ,θ_{N})=Σₙ₌₁^{N}(θₙ)ϕₙ (7)

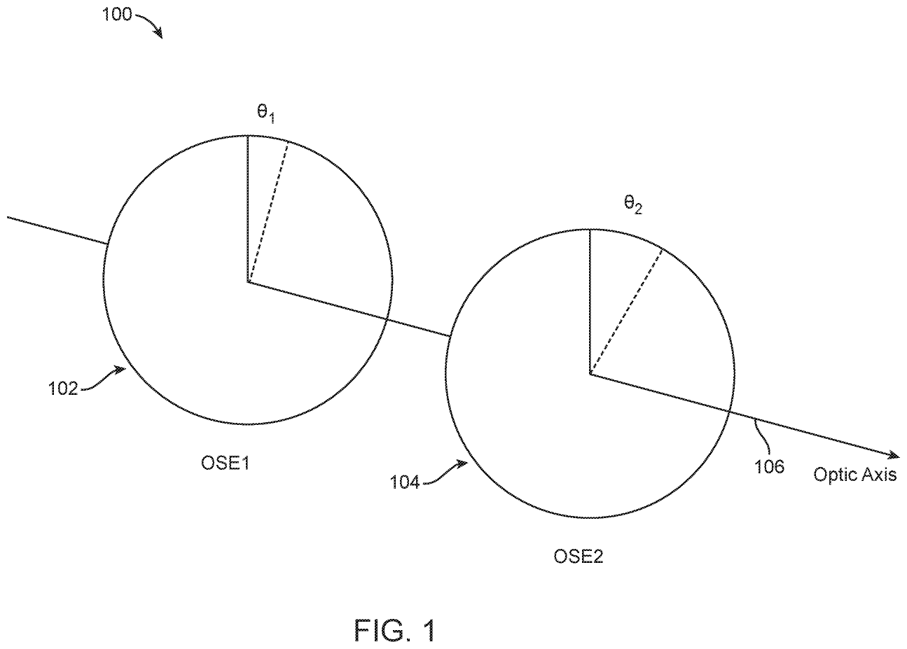

FIG. 1 depicts a representation of an example optical device 100 including two optical sub-elements 102 and 104. The two OSEs 102 and 104 are arranged in sequence along a same optical axis 106 in close proximity to each other. The phase profiles of the two OSEs 102 and 104 can be denoted by ϕ₁ and ϕ₂. Applying Equation (7) to the optical device shown in FIG. 1, the net phase profile of the optical device 100 can be expressed, for example, by Equation (8) below:

ϕₙₑₜ=ϕ₁+ϕ₂ (8)

By taking into account the rotation of each of the two OSEs 102 and 104, the net phase profile of the optical device 100 can be expressed in terms of the rotation angles θ₁ and θ₂, as shown below in Equation (9):

ϕₙₑₜ(θ₁,θ₂)=R(θ₁)ϕ₁+R(θ₂)ϕ₂≡(r,θ+θ₁)+φ₂(r,θ+θ₂) (9)

where θ denotes a referential angular position with respect to which the angles θ₁ and θ₂ are measured, and r denotes a radial coordinate.

In one or more implementations, such as in spherical lenses, the phase profile can be rotationally symmetric about the optical axis, such that ϕₙₑₜ=R(θ)ϕₙₑₜ. In this case, Equation 9 can be represented by the relative angle between the two OSEs, as shown below, for example, in Equation (10):

ϕₙₑₜ=R(θ₁)(ϕ₁+R(θ₂−θ₁)ϕ₂)=R(−θ₁)ϕₙₑₜ≡R(−θ₁)[R(θ₁)(ϕ₁+R(θ₂−θ₁)ϕ₂)]=(ϕ₁+R(θ₂−θ₁)ϕ₂)≤ϕ₁+R(Δθ)ϕ₂ (10)

where Δθ=θ₂−θ₁ is the relative orientation between the two OSEs.

It follows that the OSEs 102 and 104 themselves cannot all be rotationally symmetric, otherwise ϕₙₑₜ would not have a dependence on the relative angle. Therefore, a rotationally asymmetric profile can be used for at least one of the OSEs 102 and 104.

A static lens, which is initially rotationally symmetric and has one fixed focal length, can be adapted to have variable focus by using two OSEs 102 and 104. In this example, the rotationally symmetric phase profile of lens can be used as one mathematical component in the OSEs but can be altered to include a rotationally asymmetric component. For example, a standard hyperboloidal phase profile ϕₗₑₙₛ of a static collimating lens with can be represented by Equation (11) below:

ϕₗₑₙₛ=−2π/λ(√(r²+f²)−f) (11)

where r is the radial coordinate, f is the focal length, and λ is the wavelength. The collimating lens is rotationally symmetric. That is, R(Δθ)ϕₗₑₙₛ=ϕₗₑₙₛ(θ+Δθ)=ϕₗₑₙₛ.

To implement rotational asymmetry, a rotationally asymmetric component, ϕᵣₒₜ(θ), such as a spiral like phase profile, can be used to modify the phase profile of each OSE. For example, the phase profiles for the two OSEs can be expressed as shown in Equations 12A and 12B below:

ϕ₁=ϕₗₑₙₛϕ_{rot,1} (12A)

ϕ₂=ϕₗₑₙₛϕ_{rot,2} (12B)

where ϕ_{rot,1} and ϕ_{rot,2} can be expressed, for example, as shown in Equations 13A and 13B below:

ϕ_{rot,1}=−θ (13A)

ϕ_{rot,2}=θ (13B)

The net phase profile, as described in Equation (10) above, can be expressed as:

ϕₙₑₜ=Δθϕₗₑₙₛ (14)

By including the expression for the phase profile ϕₗₑₙₛ from Equation (11) above in Equation (14), the net phase profile can be expressed as shown below in Equation (15):

ϕₙₑₜ=−Δθ2π/λ(√(r²+f²)−f) (15)

Thus, Δθ behaves as a coefficient multiplying the conventional lens phase profile. The coefficient Δθ effectively provides a way to adjust focal length by varying the relative angle.

In this case, however, a discontinuity in the phase profile imposed by the choice of ϕᵣₒₜ=θ introduces a discontinuity in the net phase. This manifests itself on the device level as a bifocal phase profile, in which one region of the profile has one focal power and the other region has a different focal power. In one or more example implementations, the discontinuity in the phase profile can be represented by a branch cut, which is a curve in the complex plane across which the phase profile is discontinuous. The phase profile can be represented as an analytic multivalued function ϕ(x, y)=ϕ(x, y)+2π. The branch cut represents a discontinuity in a spatial path or line on the function.

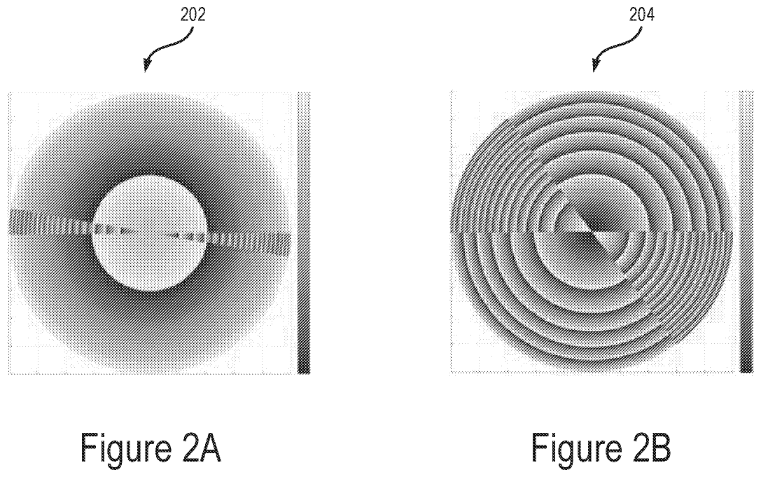

FIGS. 2A and 2B show representations of net phase profiles 202 and 204 of an optical device having at least two optical sub-elements arranged at relative angles of 10.8° and 54°, respectively. The net phase profiles 202 and 204 shown in FIGS. 2A and 2B show discontinuities. In particular, each of the net phase profiles 202 and 204 includes two regions with different sizes and different focal lengths. However, as the relative angles between the two OSEs increases, the difference in the sizes and the focal lengths associated with the two regions decreases, as shown in FIG. 2B.

While a bifocal or multifocal tunable optical element may be desirable, in many cases, just a singular focal length may be included. One technique of achieving a singular focal length includes reducing the aforementioned discontinuity by selecting an appropriate rotationally asymmetric component ϕᵣₒₜ, such that the discontinuity is distributed evenly across the surface of the optical device. The rotationally asymmetric component ϕᵣₒₜ can be modified using phase discontinuity distribution (referred to here as PDD), such that a majority single focal power profile for a large range of rotation angles can be achieved. This technique can also be applied other device designs in addition to lenses. In one example, the rotationally asymmetric component ϕᵣₒₜ modified using PDD can be expressed as shown below in Equation (16):

ϕ_{rot,PDD}=(Ar+Bθ)mod 2π (16)

where A and B are parameters that define an Archimedes-type spiral to provide for rotational asymmetry and mod is the modulo operation which enhances PDD through symmetrization.

For example, a possible implementation could have A=100 and B=2. In one or more example implementations, rotational symmetry can be provided by spirals of types other than the Archimedes-type spiral mentioned above. The other types of spirals can include, for example, hyperbolic spiral/inverse spiral, lituus spiral, Fermat's spiral, Cornu spiral, Epispiral, Fibonacci spiral/golden spiral, logarithmic spiral, Nielsen's spiral/Sici spiral, polygonal spiral, and Theodorus spiral.

By setting ϕ_{rot,1}=−ϕ_{rot,2}, we can obtain OSE phase profiles for the first and the second OSE, as described below in Equations (17A) and (17B):

ϕ₁=−2π/π[√(r²+f²)−f][(Ar+Bθ)mod 2π] (17A)

ϕ₂=2π/λ[√(r²+f²)−f][(Ar+Bθ)mod 2π] (17B)

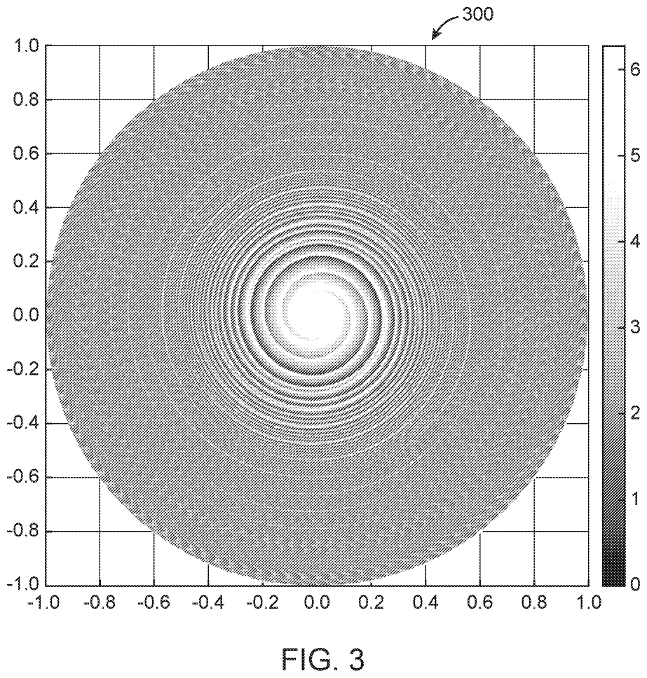

FIG. 3 depicts a representation of an example phase profile 300 of an optical sub-element utilizing phase discontinuity distribution. This OSE can be used in conjunction with its phase conjugate (i.e., negative phase profile), to provide an optical device with a single majority focal length.

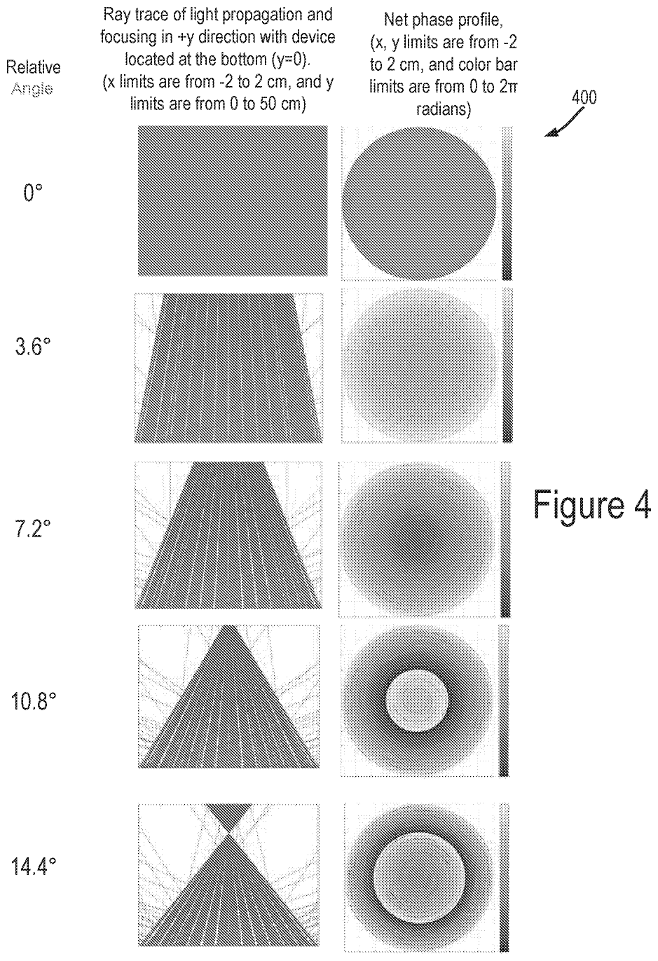

FIG. 4 depicts representations of net phase profiles 400 of an optical device using two optical sub-elements. In particular, the optical device uses a first OSE with a phase profile similar to that shown in FIG. 3 and a second OSE having a phase profile that is a conjugate to that of the first OSE. The resulting ray tracing calculation of light passing through the device as well as the corresponding net phase profile of the device is shown for various relative angles. By increasing the relative angle from 0° to 14.4°, the focal length can be changed from infinity to 40 cm. Plot limits are fixed to emphasize action of focal length tuning on the bending of light rays. Ray traces of 0° to 10.8° show focusing outside of plot limits due to long focal length. A single majority focal length is shown in the presence of a minority focal length, which is distributed throughout the surface the device by means of PDD. This can be seen in the ray tracing calculation as stray rays as well as in the phase profile as a thin spiral structure overlapping the majority focusing phase profile.

While several optical device using OSEs discussed above can be implemented using Equations (2) and (7), in some examples, optical devices similar to those discussed above can be formed using static optical elements by converting these elements into tunable optical elements. For example, an optical functions Fₙ of each OSE can be adapted from the optical function F_{static} that describes that analogous static optical element, as shown below in Equation (18):

Fₙ=F_{rot,n}F_{static} (18)

where F_{rot,n} is a rotationally asymmetric function that modifies F_{static}. Specifically, a phase profile of an optical device can be described as shown below in Equation (19):

ϕₙ=ϕ_{rot,n}ϕ_{static} (19)

where ϕ_{static} is the phase profile of the analogous static optical element and ϕ_{rot,n} is a function that provides rotational asymmetry for the OSE, such as the one provided in Equation (16) above.

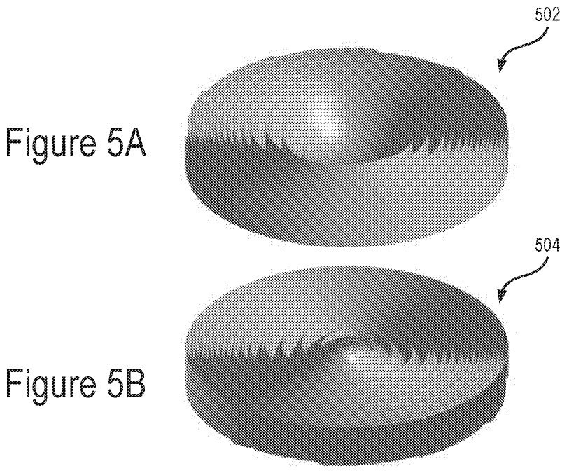

FIGS. 5A and 5B depict representations of optical sub-elements formed using bulky optics. In particular, FIGS. 5A and 5B show two OSEs 501 and 504 with conjugate rotational phase profiles. The phase profiles of the optical device discussed above in relation to FIGS. 3 and 4 can be converted into corresponding optical path lengths, which, in turn, can be manufactured by manipulating the surface geometry of an optical material having suitable refractive index. In one or more implementations, techniques such as diamond turning, or microscale/nanoscale 3D printing can be used to manufacture the OSEs.

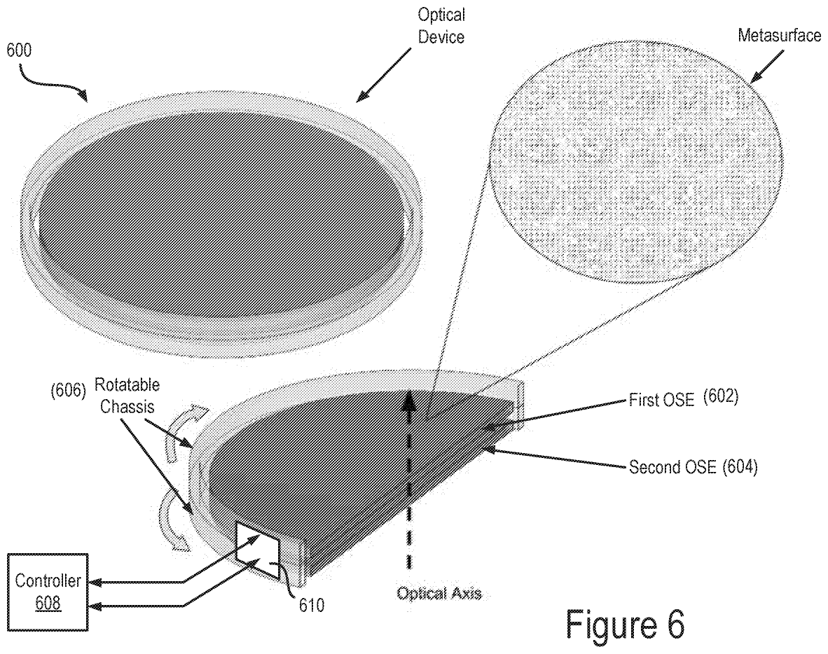

FIG. 6 depicts a representation of an example optical device 600 including planar tunable lenses. The optical device includes two OSEs 602 and 604 mounted in close proximity on a rotatable cylindrical chassis 606 that allows setting of a relative rotational angle (or a relative angular position) between the two OSEs 602 and 604. Each OSE can be a planar optical element (POE), such as a metasurface lens. A cross-sectional view of the optical device is shown in addition to a close-up view of the metasurface lens. The close-up view shows small surface structures designed to accurately produce the phase profile of each corresponding OSE. The rotatable chassis 606 can include, or can be coupled to, one or more prime actuators or movers 610 that provide a mechanical force for rotating the two OSEs 602 and 604. The prime movers can include, for example, an electric motor, a MEMS device, a piezoelectric driver, and the like. The optical device 600 can include a controller 608 that can communicate with the rotatable chassis 606 to set the relative rotational angles. The controller 608 and the rotatable chassis 606 can form a control mechanism for controlling the relative rotational angles of the two OSEs 602 and 604. The controller 608 can include, for example, a microprocessor, a microcontroller, or an application specific integrated circuit that is configured to send instructions to the rotatable chassis 606 to set the desired relative rotational angle. In one or more embodiments, the controller 608 can include a memory that stores instructions and data, which when executed by the controller 608 can allow the controller to communicate with the chassis 606 to set the desired rotational angles of the two OSEs 602 and 604. In one or more embodiments, the controller 608 can include one or more port (serial data, parallel data, network) configured to allow the controller 608 to communicate with other devices or controllers to send and receive data and instructions related to the setting of the rotational angle. In one or more embodiments, the controller 608 can receive instructions to set a focal length of the optical device 600, and can determine corresponding a relative rotational angle between the two OSEs 602 and 604 based on the discussion above. The controller 608 can determine the appropriate electrical signals or the data to be sent to the rotatable chassis 606 to cause the rotation of one or both the OSEs such that the relative rotational angle is set at the desired value. In one or more embodiments, the controller 608 can set the values of individual OSEs or the relative rotational angle can be can be configured to cause discrete, continuous or oscillatory changes in the positions of the OSEs 602 and 604.

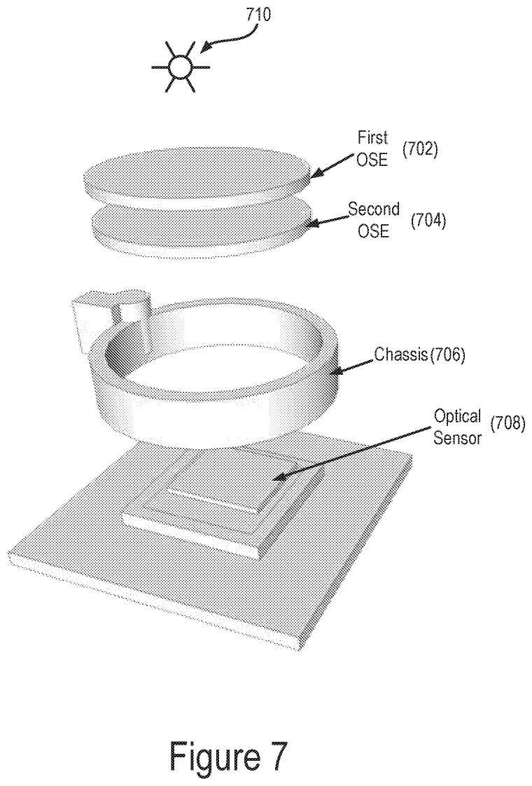

FIG. 7 depicts an expanded view of another example optical device 700 used in conjunction with an optical sensor. In particular, the optical device includes a first OSE 702, a second OSE 704, and a chassis 706, which provides the ability to control the relative angles of the first and second OSEs. The optical device can be mounted over an image sensor 708, where, in one or more examples, the image sensor can be an integrated circuit. The first and second OSEs 702 and 704 can process light emitted by a light source 710 before it is incident on the image sensor 708. For example, the relative angles of the first and the second OSEs 702 and 704 can be adjusted to change the focal length of the light emitted by the light source 710 and incident on the image sensor 708.

For the optical devices discussed herein, dynamic and high-speed tuning can be done in an analog or digital manner at the millisecond time scale. The optical devices discussed herein can be used to implement embedded autofocus and optical zoom for chip-scale image sensors (e.g. cell phone cameras) as well as optical zoom and adaptive focus with lightweight form factors for head mounted optics, such as everyday eyeglasses, virtual reality and augmented reality hardware, heads-up displays, projectors, and optical disc drives. In other applications, the capabilities of the optical devices discussed herein allow for optical zoom and focal plane scanning for cameras, telescopes, and microscopes as well as in biomedical applications such as artificial intraocular lenses without the need for longitudinal movement about the optical beam path. In one or more implementations, flat construction of the optical devices allows for highly-stackable systems, such as compound optics. Additionally, the optical devices can be well-suited to MEMS integration. The optical devices can be mass produced at low cost using various manufacturing pathways, such as standard injection molding processes (one example of which is shown in FIG. 5) as well as foundry fab processes, e.g. CMOS (examples of which are shown in FIGS. 6 and 7). The power consumption of these optical devices can be advantageously low or even draw no power at all, since power is used to change the focal length, not to maintain it. In general, anything and anywhere that specifies a focusing lens or tunable optical element can apply this technology.

In one or more examples, the optical devices discussed herein can be used to form a wide range of common and exotic variable optical elements, such as axicons, geometric phase devices, variable angle deflectors (scaled linear phased array), and scaled holograms (c.f. wavelength dependence of holograms). The optical device can also be used to form new types of POE devices for wavefront correction, spatial light modulation, as well as other types of adaptive optics.

In one or more examples, the optical devices discussed herein can include two planar optical elements (or OSEs) in which a focal length of the optical device is tuned in a linear manner by varying the relative angular position between the two planar optical elements. The relative angle between the OSEs can be electronically controlled and actuated. For example, the angular positions of the OSEs can be controlled and actuated using one or more of an electric motor, an electric field, a magnetic field, a mechanical force, a MEMS device, and a piezoelectric driver. A device used for controlling and actuating the positions of the OSEs can provide discrete, continuous or oscillatory changes in the positions of the OSEs.

In one or more examples, the OSEs can be planar optical elements (POE), such as diffractive optical elements, Where the POE is composed of a multitude of smaller, individual elements. The individual element can have a size that is subwavelength, i.e. smaller than the wavelengths of light for which the POE is designed; or wavelength scale or larger. The spacing between individual elements can be such that a center-to-center distance between elements is fixed. The spacing can also be such that an edge-to-edge distance between the individual elements is fixed. The spacing can also be arbitrary. The OSEs also can be formed using bulky optical elements, such as refractive optical elements or freeform optics. The OSEs also can be formed using a combination of POEs and bulky optical elements.

The OSEs of the optical device can operate in a transmissive or a reflective mode. The OSEs peripheral boundary can be made of any shape, including, for example, rectangular, circular, and elliptical. The OSEs can be constructed using materials such as glass, amorphous silicon, silicon dioxide, titanium dioxide, silver, and aluminum. The POEs can be designed for any suitable wavelength or a range of wavelengths. For example, the POEs can be designed for a narrowband or a single wavelength, or a broadband or multi-band wavelengths. The wavelengths can be in the visible, near-infrared, mid-infrared, far-infrared or in other spectral ranges. The OSEs can process light with any state of polarization such as linear, circular, or elliptical. The OSEs can be designed to not perform a separate action on orthogonal polarizations. The OSEs can be designed to also process un-polarized or partially polarized light.

The OSEs can have a spatial pattern, where phase or geometric phase, amplitude, or polarization can be defined at each location in the pattern. The OSEs can function as a focusing element, such as a lens, axicon, bifocal, or multifocal element. The OSEs can also function as a beam deflector, a phase array or metasurface, a photonic crystal, a diffraction grating, a monofocal diffractive grating, a polarizer, a beam splitter (polarizing or non-polarizing), a depolarizer, a diffuser, an optical attenuator (such as a neutral density filter, a bandpass filter and an edge-pass filter), a Fabry-Perot resonator, a retroreflector, a wave plate or retarder, or an aperture. In one or more examples, a metasurface includes a substrate and multiple nanoscale structures, or nanostructures, disposed on the substrate. In some examples, a cross-section of at least one nanoscale structure is rectangular or other polygonal shape. In some examples, a cross-section of at least one nanoscale structure is elliptical or circular. In some examples, a cross-section of nanoscale structures can have a 2-fold rotational symmetry, or more generally, an n-fold rotational symmetry where n is an integer that is 2 or greater than 2.

In some examples, nanoscale structures are composed of a semiconductor, an oxide (e.g., a metal or non-metal oxide), a nitride (e.g., a metal or non-metal nitride), a sulfide (e.g., a metal or non-metal sulfide), a pure element, or a combination of two or more of these.

In some examples, a substrate is a glass substrate or one including fused silica.

In some examples, nanoscale structures include a dielectric material. Examples of suitable dielectric materials include metal and non-metal oxides (such as an oxide of aluminum (e.g., Al₂O₃), silicon (e.g., SiO₂), hafnium (e.g., HfO₂), zinc (e.g., ZnO), magnesium (e.g., MgO), or titanium (e.g., TiO₂)), metal and non-metal nitrides (such as nitrides of silicon (e.g., Si₃N₄), boron (e.g., BN), or tungsten (e.g., WN)), metal and non-metal sulfides, and pure elements (e.g., silicon for operation at near-infrared and mid-infrared wavelengths).

In some examples, nanoscale structures have aspect ratios (e.g., height:width) greater than about one, such as at least about 1.5:1, at least about 2:1, at least about 3:1, at least about 4:1, or at least about 5:1, and up to about 10:1 or greater, or up to about 20:1 or greater. In some examples, geometric dimensions (e.g., height/width/length or diameter/height) of nanoscale elements are sub-wavelength, such as about 800 nm or less, about 700 nm or less, or about 600 nm or less.

In one or more examples, the POEs can be analogously designed as planar acoustic elements (PAEs) including acoustic metamaterials, for shaping a wavefront of acoustic waves such as ultrasonic waves. The acoustic phase profile of the PAEs can be analogous to the optical phase profile of the POEs. Acoustic metamaterials mold the wavefront of sound. This is done by designing the local speed of sound over the metamaterial. The local speed of sound can be engineered by controlling the shape, elasticity, compressibility, density, mass of the material locally. Many materials can be used such as foams, composites, woods, polymers, ceramics, metals, and so forth. Examples of structures of the acoustic metamaterials include an array of different masses, an array of different material membranes, an array of different multilayer membranes, and an array of different shapes, but formed of the same material.

The optical device discussed herein can be used in several applications. For example, the optical device can be used to implement electrically tunable lenses such as corrective lenses such as eyeglasses or contact lenses; magnifiers such as magnifying glass, microscopes, or beam expanders; photographic lenses such as varifocal lens, zoom lens, fisheye lens, anomorphic lens, mirror lens (for example, catadioptric lens and reflex lens), corrector plates (for example, full aperture correctors, sub-aperture correctors, and aberration correctors), perspective control lens, lenses used to introduce optical special effects (for example, soft focus lens and starlight lens), and stereoscopic lens; and projection lenses such as image or video projection lenses, photographic reduction lenses, and photolithography lenses.

The optical device discussed herein can include a stack of multiple electrically tunable POEs. In one example, the focal lengths of all POEs are tuned or some POEs are tuned and some are not tuned. In one example, the distance of separation between the POEs is fixed. In one example, the distance of separation between the POEs is variable. The distance of separation can be controlled using an ultrasonic motor, a piezoelectric motor, a stepper motor, or other types of motors. In one example, the effective variable focus of the optical device can be enhanced by using multiple POEs. In one example, the optical device can be used to implement a parafocal lens, for which a focal plane remains unchanged despite a change in magnification. In one example, focus and magnification can be independently controlled. In one example, the POEs operate in conjunction such that aberrations such as spherical aberration, chromatic aberration, and coma are reduced or removed. The optical device can include conventional bulky lenses in addition to the POEs as part of a compound lens optical system.

The optical device discussed herein can be used in imaging systems in which a focusing mechanism is implemented using electrical control. In one example, the electric control can include a manual focusing mechanism such as a wheel, button, screw, switch, slider, or computer control etc. that allows for manual tuning of a control voltage corresponding to controlling a focal length. In one example, the electric control can include an electrical feedback mechanism that adjusts a control voltage corresponding to the focal length in order to perform autofocusing. In one example, the autofocusing mechanism can include measuring a distance from the optical device to an object by using sound waves (e.g. ultrasonic) or light (e.g. infrared). In one example, the autofocus mechanism can include phase detection, either by closed-loop control or open-loop control. In one example, the autofocus mechanism can include contrast detection. In one example, the autofocus mechanism can include an assist lamp, e.g., with an autofocus illuminator, in order to provide extra light in performing phase detection or contrast detection. In one example the electrical control can include A hybrid autofocus system in which autofocus is achieved by a combination of the above mentioned autofocus mechanisms. In one example, the electrical control can include a control system to perform trap focus (i.e., focus trap or catch-in-focus), in which an action of a subject moving into a focal plane activates an acquisition of an image. In one example, the electrical control can include a control system that maintains focus on a subject of interest, i.e., focus tracking, by adjusting a voltage and hence the focus in accordance with a distance or appearance of a subject.

In one example, the optical device discussed herein can be used in imaging systems in which the focus or focal plane is scanned across multiple lengths in a continuous or discrete manner. In one example, the optical device discussed herein can be used in imaging systems in which a confocal microscope configuration is used. In one example, the optical device discussed herein can be used in imaging systems that perform 3D imaging.

In one example, the optical device discussed herein can be used in communication applications, such that a degree of defocusing or power transmitted can be used to encode information. In one or more examples, the optical device discussed herein can be used in electrically tunable optical systems such as catoptric (reflection-based) systems, dioptric (transmission-based) systems, catadioptric (hybrid reflection and transmission based) systems, photographic cameras, cell phone cameras, video cameras, searchlights, headlamps, optical telescopes, microscopes, telephoto lens systems, microlens arrays, head-mounted optics systems, and volumetric projection systems.

In one or more examples, the optical devices discussed herein also can be used in other electrically tunable optical devices and systems such as a fiber coupler, a variable coupler, a mode converter, a collimator, an optical modulator, an optical phase shifter, a polarization state generator, a polarimeter, an ellipsometer, a spectrometer, an interferometer, an optical chopper, a fast change optical filter, an optical tweezer, a phase compensator, adaptive optics, a noise eater or laser amplitude stabilizer, a vortex plate for generating light beams with orbital angular momentum, q-plates, an optical power concentrator, or an optical disc drive.

In one or more examples, the optical device discussed herein also can be used in applications such as image sensors, cameras, endoscopes, machine vision applications, phased arrays, lasers, lenslet arrays, lithotripsy, medical imaging, dichroic filters or mirrors, and combinations thereof.

As used herein, the singular terms “a,” “an,” and “the” may include plural referents unless the context clearly dictates otherwise.

As used herein, the terms “approximately,” “substantially,” “substantial” and “about” are used to describe and account for small variations. When used in conjunction with an event or circumstance, the terms can refer to instances in which the event or circumstance occurs precisely as well as instances in which the event or circumstance occurs to a close approximation. For example, when used in conjunction with a numerical value, the terms can refer to a range of variation less than or equal to ±10% of that numerical value, such as less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%. For example, two numerical values can be deemed to be “substantially” the same if a difference between the values is less than or equal to ±10% of an average of the values, such as less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%.

Additionally, amounts, ratios, and other numerical values are sometimes presented herein in a range format. It is to be understood that such range format is used for convenience and brevity and should be understood flexibly to include numerical values explicitly specified as limits of a range, but also to include all individual numerical values or sub-ranges encompassed within that range as if each numerical value and sub-range is explicitly specified.

While the present disclosure has been described and illustrated with reference to specific embodiments thereof, these descriptions and illustrations do not limit the present disclosure. It should be understood by those skilled in the art that various changes may be made and equivalents may be substituted without departing from the true spirit and scope of the present disclosure as defined by the appended claims. The illustrations may not be necessarily drawn to scale. There may be distinctions between the artistic renditions in the present disclosure and the actual apparatus due to manufacturing processes and tolerances. There may be other embodiments of the present disclosure which are not specifically illustrated. The specification and drawings are to be regarded as illustrative rather than restrictive. Modifications may be made to adapt a particular situation, material, composition of matter, method, or process to the objective, spirit and scope of the present disclosure. All such modifications are intended to be within the scope of the claims appended hereto. While the methods disclosed herein have been described with reference to particular operations performed in a particular order, it will be understood that these operations may be combined, sub-divided, or re-ordered to form an equivalent method without departing from the teachings of the present disclosure. Accordingly, unless specifically indicated herein, the order and grouping of the operations are not limitations of the present disclosure.

What is claimed is:

1. An optical device comprising:
a plurality of optical sub-elements (OSEs); and
a rotatable chassis supporting the plurality of OSEs, the rotatable chassis configured to set relative angular positions of at least two OSEs of the plurality of OSEs,
wherein a focal length of the optical device is based on the relative angular positions of the at least two OSEs of the plurality of OSEs.

2. The optical device of claim 1, wherein a phase profile of each of the at least two OSEs of the plurality of OSEs is spiral shaped and rotationally asymmetric.

3. The optical device of claim 2, wherein a phase profile of at least one OSE of the plurality of OSEs is a phase conjugate of a phase profile of another OSE of the plurality of OSEs.

4. The optical device of claim 2, wherein a surface geometry of at least one of the at least two OSEs of the plurality of OSEs defines an optical path length, which is based on the respective phase profile.

5. The optical device of claim 1, wherein the at least two OSEs are positioned at a distance of about 10 μm to about 2 μm from each other.

6. The optical device of claim 1, wherein at least one OSE of the plurality of OSEs is a planar optical element (POE).

7. The optical device of claim 6, wherein the POE includes a metasurface.

8. The optical device of claim 1, further comprising a controller communicably coupled to the rotatable chassis, wherein the rotatable chassis sets the relative angular positions of the at least two OSEs based on a signal received from the controller.

9. The optical device of claim 7, further comprising an actuator including at least one of an electric motor, a piezoelectric motor, or a microelectromechanical systems (MEMS) driver, coupled to the rotatable chassis.

10. The optical device of claim 1, further comprising an image sensor, wherein the plurality of OSEs are configured to be positioned in relation to the image sensor to process light entering the image sensor.

11. The optical device of claim 1, further comprising a light source, wherein the plurality of OSEs are configured to be positioned in relation to the light source to process a projecting image generated by the light source.

12. A method comprising:
providing a plurality of optical sub-elements (OSEs) of an optical device;
determining relative angular positions of at least two OSEs of the plurality of OSEs corresponding to a focal length of the plurality of OSEs; and
controlling a rotatable chassis supporting the plurality of OSEs to set the positions of the at least two OSEs of the plurality of OSEs.

13. The method of claim 12, wherein a phase profile of each of the at least two OSEs of the plurality of OSEs is spiral shaped and rotationally asymmetric, and wherein determining the relative angular positions includes determining the relative angular positions based on the phase profile of each of the at least two OSEs.

14. The method of claim 12, wherein a phase profile of at least one OSE of the plurality of OSEs is a phase conjugate of a phase profile of another OSE of the plurality of OSEs.

15. The method of claim 12, further comprising positioning the at least two OSEs at a distance of about 10 μm to about 2 μm from each other.

16. The method of claim 12, wherein a phase profile of at least one OSE of the plurality of OSEs is specified based on a phase discontinuity distribution function.

17. The method of claim 12, wherein at least one OSE of the plurality of OSEs is a planar optical element (POE).

18. The method of claim 12, wherein controlling the rotatable chassis supporting the plurality of OSEs includes controlling at least one of an electric motor, a piezoelectric motor, or a microelectromechanical systems (MEMS) driver.

19. The method of claim 12, further comprising receiving light from a light source at the plurality of OSEs and providing light from the plurality of OSEs to an image sensor.

20. The method of claim 12, further comprising receiving light from light source at the plurality of OSEs and providing light from the plurality of OSEs to a projection screen.
